(19) United States
(12) Patent Application Publication
(10) Pub. No.: US 2016/0332855 A1
(43) Pub. Date: Nov. 17, 2016

(54) LIFTING DEVICE IN THE FORM OF A LIFTING COLUMN

(71) Applicant: SEFAC, Montherme (FR)

(72) Inventor: Eric LETELLIER, Charleville (FR)

(21) Appl. No.: 15/109,424

(22) PCT Filed: Dec. 30, 2014
(86) PCT No.: PCT/FR14/53581

§ 371 Date: Jun. 30, 2016

(30) Foreign Application Priority Data
Dec. 31, 2013 (FR) 1363730

(51) Int. Cl. B66F 17/00; B66F 7/02

(52) U.S. Cl. CPC B66F 17/00; B66F 7/025

(57) ABSTRACT

A lifting device for vehicles includes a column forming a frame, extending substantially vertically above a base, and a lifter movable along the column by controlling the rotation of a threaded rod by a driving device and by the movement, along the threaded rod, of a nut secured to a carriage on which the load to be lifted can rest. There is a fall-arresting safety device including a ratchet occupying at least a first unlocked position and a locked position engaging with at least one tooth of a ratchet wheel so as to lock the rotation of the threaded rod. There is a retaining device for the ratchet in the unlocked position and a controller for the return of the ratchet to the locked position.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

1. Field of the Invention

The present invention relates to a lifting device, also called lifting column, in particular for a vehicle, comprising a substantially vertical column forming a frame and lifting means movable along said column under the action of the rotational control, by appropriate motor means, of a threaded rod and the movement, along the latter, of a nut secured to a carriage on which the load to be lifted can rest.

The present invention is applicable in the field of handling devices, and more particularly lifting devices, in particular for vehicles.

2. Description of Related Art Including Information Disclosed Under 37 CFR 1.97 and 37 CFR 1.98.

The safety of lifting stations, in particular for motor or rail vehicles, is a significant problem, to which various responses have been provided.

Many lifting devices exist, such as a vertical column forming a frame resting on the ground via a base. Lifting means including a moving carriage equipped with one or more horizontal arms are able to move along such a vertical column. The movement of the moving carriage is guided along the column via guide means equipping the latter and complementary guide means with which this carriage is equipped.

The control of the movement of the carriage is more particularly obtained via a vertical threaded rod extending along the column and able to be driven by a motor means, in particular of the electric type, equipping the column head. Furthermore, a nut, secured to the lifting means, is mounted on the threaded rod such that, during the rotational control of the latter, this nut rises or lowers, thereby driving said lifting means.

Clearly, these lifting devices, intended to lift relatively significant loads, include a certain number of safeties preventing the load from lowering upon any failure, in particular motor means.

The use of so-called irreversible nuts is known, whereof the helix angle is such that in the lowering direction of the load, it opposes a resisting torque with a moment greater than the torque produced by the lowering of said load. The use of such nuts, with a low performance, subject to high friction and significant wear, requires a lubrication installation, as well as a significant driving power, which results in a high cost.

Other systems use reversible nuts, with a high performance, of the ball nut type, or made from polyamide or a composite material. Such systems incorporate parachute systems controlled electrically or electronically serving to detect an involuntary lowering of the lifting means instantaneously, and to immobilize the latter immediately. However, such systems themselves must be backed up, since the parachute system is at the mercy of the slightest failure of a circuit or connection.

Document FR 2,701,252 proposes the use, combined with a reversible nut, of friction means able to create, during the lowering of the lifting means, a resisting torque with a moment greater than or equal to that of the torque produced by the load during lowering thereof. The system also includes means able to destroy the effect of the friction means when commanding the raising of the lifting means. This solution, which is reliable, nevertheless requires producing significant energy when commanding the lowering of the load.

Also known from document FR 2,901,780 is a safety nut that is placed immediately below the lifting nut controlling the raising and lowering of the load. This lifting nut is generally made from a material with a low friction coefficient, in particular bronze, knowing that in case of wear, or even breaking of the thread of this lifting nut, it rests on the safety nut. The latter is made from a stronger material, in particular steel, which conversely provides a higher friction coefficient. Consequently, only an emergency lowering maneuver is generally possible when the load is no longer supported by the bronze nut, but instead by this safety nut. It

Another state of the art consists of equipping the column with a rack with which a ratchet is engaged. This rack therefore extends over substantially the entire height of the column, and if the lifting means break, the tooth of the ratchet engaged with the rack prevents the load from falling.

Although the rack-ratchet solution makes it possible to secure the lifting column, irrespective of the failing means in terms of the kinematics of the lifting mechanism, it has the drawback that in case of break, it necessarily results in a drop of the lifting carriage, therefore of the load, from a height corresponding to the pitch of the rack, in other words by a distance corresponding to the separation of two teeth on said rack. In this respect, it should be recalled that the weight of the load that a tooth is able to bear depends on the size of that tooth. Thus, this fall height in case of break is often approximately two centimeters, which is far from negligible given that the loads that such lifting columns can lift may be several tons.

### BRIEF SUMMARY OF THE INVENTION

The invention aims to offset the drawbacks of the state of the art by proposing a cost-effective solution that makes it possible, in case of failure, to reduce the fall risk of the lifted load to several millimeters or less. This solution also makes it possible to equip and secure existing installations, at a lower cost and without requiring a lengthy immobilization.

Above all, inventively and going somewhat against the prejudices of one skilled in the art in the field, it has been noted that the known systems, using a traditional nut, call on safety solutions making it possible to address the issue of wear and therefore breaking of this nut, without ever worrying about a potential failure of the motor part. More particularly, the motor typically acts on the threaded rod through a reducing gear, often of the reversible type, such that in case of power outage, the rotation of said threaded rod is blocked. The present invention aims to provide an advantageous solution to these difficulties.

To that end, the invention relates to a lifting device, in particular for a vehicle, comprising a column forming a frame, extending substantially vertically above a base, and lifting means movable along said column under the action of the rotational control, by appropriate motor means, of a threaded rod and the movement, along the latter, of a nut secured to a carriage on which the load to be lifted can rest, this lifting device further including fall arresting safety means for the lifted load, characterized in that the fall arresting safety means include a ratchet able to occupy at least a first unblocking position and a blocking position cooperating with at least one tooth of a ratchet wheel to block the rotation of the threaded rod, as well as retaining means in the unblocking position and control means for returning to the blocking position.

According to one preferred embodiment, the ratchet wheel or, respectively, the ratchet is mounted secured in rotation on said threaded rod, while the ratchet or, respectively, the ratchet wheel is secured to the frame-forming column.

Advantageously, the control means for returning the ratchet to the blocking position assume the form of a return spring tending to push it toward the ratchet wheel so as to engage it against at least one tooth included by the latter.

According to another particularity of the invention, the means for keeping the ratchet in the unblocking position are made up of an actuator of the electromagnetic type able to counter the force of said return spring to keep the ratchet separated from the hold of said tooth.

Owing to these arrangements, in case of failure of said motor means, in particular the brake of a gear motor, the electromagnet may receive the order to no longer keep the ratchet in the unblocked position, such that under the action of the return spring, it is able to engage against the following tooth that presents itself and block the rotation of the threaded rod. The untimely fall of the nut and the carriage is thus limited to no more than one revolution of the threaded rod.

According to one feature of the invention, the ratchet wheel may include at least four teeth, preferably distributed on the periphery, making it possible to further reduce the untimely fall of the carriage in case of failure of the motor means, which may represent a fall height of 2 or 3 millimeters, or even less.

According to an additional feature of the invention, said threaded rod may be suspended by its upper end and include a cone trunk at its lower end, able to cooperate with a frustoconical orifice associated with the base. Such an arrangement makes it possible to avoid a fall of the carriage in case of failure of the suspension means of the threaded rod.

According to one particular feature, the frustoconical orifice, with which the cone trunk-shaped lower end of said threaded rod cooperates, is arranged in a part in the form of a carriage made horizontally translatable at the base, so as to avoid lateral bearing of the end of the threaded rod on the walls of the orifice during normal operation of the device. Indeed, during normal operation, the threaded rod is suspended and the load supported along the latter tends to impart deformations resulting in horizontal movements of the lower end of this threaded rod. The horizontally movable carriage makes it possible to avoid introducing stresses between the cone trunk at the end of the threaded rod and the walls of the frustoconical orifice, and therefore to avoid friction that would otherwise slow the rotation of the threaded rod and increase the energy consumption for the operation of the device.

### BRIEF DESCRIPTION OF THE SEVERAL VIEWS OF THE DRAWINGS

Other features and advantages of the invention will emerge from the following detailed description of non-limiting embodiments of the invention, in reference to the appended figures.

FIG. 1 is a schematic view, diagrammatically showing a lifting device according to the invention.

FIG. 2 is another schematic view, diagrammatically showing a threaded rod on which the fall arresting safety means according to the invention intervene.

FIG. 3 is also a schematic view, diagrammatically showing the ratchet in its two blocking and unblocking positions relative to the ratchet wheel.

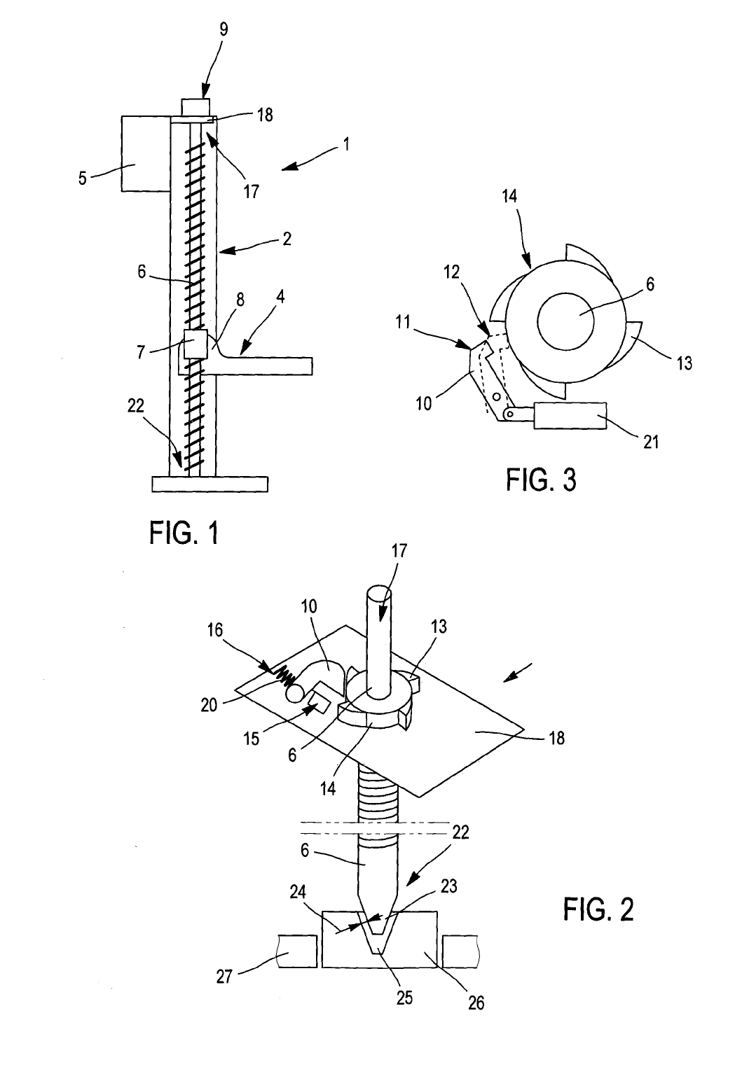

### DETAILED DESCRIPTION OF THE INVENTION

As shown in the figures of the attached drawing, the invention relates to a lifting device 1, also called lifting column, in particular designed for lifting vehicles.

Such a device 1 comprises a column 2 forming a frame and extending substantially vertically above a base 3.

It further comprises lifting means 4, which are movable along this column 2 under the action of the rotational control, by appropriate motor means 5, of a threaded rod 6 and the movement, along the latter, of a nut 7.

Resting on this nut 7, or mounted secured therewith, is a carriage 8 on which a load to be lifted can rest, not shown in the figures.

It will be understood in this respect that in order to lift a load corresponding to a vehicle, of the truck, train car, etc. type, several of these lifting devices or columns 1 are used, often an even number, so as to form a lifting bridge together that is suitable for lifting the vehicle in a balanced manner.

This lifting device 1 also includes fall arresting security means 9 for the lifted load.

Advantageously, the fall arresting security means 9 include a ratchet 10 able to occupy at least a first unblocking position 11 and a blocking position 12 cooperating with at least one tooth 13 of the ratchet wheel 14 for blocking the rotation of the threaded rod 6. These fall arresting security means 9 are completed by means 15 for keeping this ratchet 10 in the unblocking position 11 and means 16 for controlling the return to the blocking position 12.

In the embodiment illustrated in the figures, the ratchet wheel 14 is mounted secured in rotation on said threaded rod 6, while the ratchet 10 is secured to the frame-forming column 2. It should, however, be noted that it is also possible to consider a kinematic inversion consisting of securing the ratchet 10 in rotation with the threaded rod 6 and securely associating the ratchet wheel 14 with the frame-forming column 2.

It should be noted that it is common practice to suspend the threaded rod 6, by its upper end 17, from a fastening bracket 18 with which the column 1 is equipped in its upper part 19.

According to one particular embodiment, the fall arresting security means 9 are positioned at this upper end 17 suspended from the threaded rod 6.

If, as indicated above, the ratchet wheel 14 includes at least one tooth 13, it preferably includes several teeth advantageously distributed regularly over its periphery, for example four teeth, making it possible to divide the fall height by as much in case of failure. Whatever the case may be, this number of teeth 13 may of course vary depending on the loads to be reacted, and the section of the ratchet wheel 14. Thus, if the loads are lighter and/or the diameter of the ratchet wheel 14 is larger, it is possible to have a larger number of teeth 13. Even with a small number of teeth 13 such as four, in case of failure, the load may only fall by a quarter revolution of a screw, corresponding to barely several millimeters of fall.

The control means 16 for returning the ratchet 10 to the blocking position 12 assume the form of a return spring 20 tending to push it toward a position engaged in the ratchet wheel 14 so as to engage it against at least one tooth 13 included by the latter.

Thus, throughout the entire raising and under the influence of the return spring 20, the ratchet 10 may be kept pressed against the ratchet wheel 14, and in case of failure of said motor means 5, the blocking of the nut 7 in position is guaranteed.

The means 15 for keeping this ratchet 10 in the unblocking position 11 are made up of an actuator 21, preferably of the electromagnet type, to keep the ratchet 10 separated from the tooth or teeth 13 of the ratchet wheel 14.

In this embodiment, this actuator 21 is defined so as to be able to keep the ratchet 10 in this unblocking position 11, against the return force exerted by the return spring 20, to allow this ratchet 10 to allow the tooth or teeth 13 of the ratchet wheel 14 to pass, in particular when commanding the lowering of the load.

As indicated above, if this maintenance in the unblocking position 11 during the raising phase is not useful, in particular because, in this rotation direction, the teeth can define ramps so as to automatically push the ratchet 10 back upon each passage, it would be completely possible to consider that even during this phase commanding raising of the load, the actuator 21 could perform this maintenance of the ratchet 10 in this unblocking position 11.

Also according to the invention, the fall arresting security means 9 include a sensor device configured to detect a failure of the motor means 5. In this respect, these motor means 5 are typically an electric motor with an electromagnetic brake operating by zero current. More particularly, this brake blocks the rotation of the driveshaft of the motor when the power supply of the latter is cut. Thus, the rotation of the threaded rod is prevented. This is clearly not the case if this brake and/or the motor has a malfunction. Thus, the sensor device in question for example includes a current detector combined with a rotation detector, to detect a rotation of the driveshaft and/or the threaded rod despite the absence of current and, in this case, to deactivate the actuator 21, in particular if it involves an actuator of the electromagnetic type, to leave the return spring 20 free to return the ratchet 10 against the ratchet wheel 14, and to thus block the rotation of the threaded rod 6 from which the immobilization of the nut 7 results.

Likewise, the actuator 21 is configured so that in case of general power outage, it allows the return spring 20 to engage the ratchet 10 against a tooth 13, so as to allow positive safety: falling is prevented in case of power outage.

It has been indicated that the threaded rod 6 is suspended by its upper end 17 from the upper part 19 of the frame-forming column 2.

In order to offset a potential break of the means contributing to keeping this threaded rod 6 itself suspended, the latter is configured at its lower end 22 in a cone trunk 23, said end 22 fitting, with functional play 24 to ensure the free rotation of the threaded rod 6, in an orifice 25 which itself is frustoconical and arranged in a part 26 associated with the frame-forming column 2, more particularly the base 3 above which this column 2 extends.

Thus, if for example the rolling means supporting the threaded rod 6 break, said threaded rod falls, fitting through its lower end 22, in the form of a cone trunk 23, in this frustoconical orifice 24, by a height proportional to the functional play 24, resulting in immediate blocking of the vertical and rotational movement of the threaded rod 6 preventing any fall of the load.

According to one particular embodiment of the invention, the part 26 including this frustoconical orifice 25 is defined movably in at least one direction of a plane that is substantially horizontal relative to the base 3. Advantageously, this part 26 assumes the form of a horizontally translatable carriage, thus making it possible, during normal operation, to absorb small horizontal movements of the lower end of the threaded rod 6, due to the deformation of the latter following the variable forces applied on it by the load, through the carriage 8 and the nut 7. Thus, during normal operation, through this relative mobility of the part 26 and the functional play 24, the friction between the end 22 in the form of a cone trunk 23 and the frustoconical orifice 25 is negligible.

For example, guide means 27 in the form of guideways may be mounted on this base 3 to allow this mobility at least in a determined horizontal direction of the carriage defined by the part 26. Furthermore, the deformations of the threaded rod 6 typically always taking place in a same direction, the same is true for the movements of the lower end 22 of the threaded rod 6, and one skilled in the art knows perfectly how to define these movements.

The advantages following from the present invention consist of simplifying these fall arresting safety means at a lifting device in the form of a lifting column. Of course, this simplification also results in improved safety.

1. A lifting device for a vehicle, said lifting device comprising:
a column forming a frame, extending substantially vertically above a base;
lifting means movable along said column, under action of rotational control, by appropriate motor means, of a threaded rod and movement, along said threaded rod, of a nut secured to a carriage on which the load to be lifted can rest; and
fall arresting safety means for the lifted load, wherein said fall arresting safety means comprises a ratchet occupying at least a first unblocking position and a blocking position cooperative with at least one tooth of a ratchet wheel to block the rotation of the threaded rod and a retaining means in the unblocking position and control means for returning to the blocking position.

2. The lifting device according to claim 1, wherein said ratchet wheel and, respectively, the ratchet are mounted secured in rotation on said threaded rod, while the ratchet and respectively, the ratchet wheel are secured to the frame-forming column.

3. The lifting device according to claim 1, wherein said control means returns said ratchet to the blocking position said control means being comprised of a return spring pushing toward the ratchet wheel so as to engage against at least one tooth included by the ratchet wheel.

4. The lifting device according to claim 3, wherein said means for keeping the ratchet in the unblocking position are comprised of an actuator of the electromagnetic type able to counter the force of said return spring to keep the ratchet separated from the hold of a tooth.

5. The lifting device according to claim 1, wherein said ratchet wheel includes comprises at least four teeth distributed on the periphery.

6. The lifting device according to claim 1, wherein said fall arresting security means comprises a sensor device configured to detect a failure of the motor means and, through said return control means, to push the ratchet back into its blocking configuration.

7. The lifting device according to claim 6, wherein said sensor device comprises a current detector combined with a rotation detector, to detect a rotation of the driveshaft and/or the threaded rod despite the absence of current and to deactivate the actuator.

8. The lifting device according to claim 1, wherein said threaded rod is suspended by its upper end, wherein said threaded rod comprises a lower end configured in a cone trunk, fitting, with functional play in an orifice which itself is frustoconical and arranged in a part associated with the base.

9. The lifting device according to claim 8, wherein the part comprised of the frustoconical orifice is defined in the form of a carriage made horizontally translatable at the base.
